(19) United States
(12) Patent Application Publication
(10) Pub. No.: US 2004/0208490 A1
(43) Pub. Date: Oct. 21, 2004

(54) Image data recording/reproducing apparatus and image data recording/reproducing method

(75) Inventors: Hajime Akutsu, Yokohama (JP); Yousuke Douba, Hitachinaka (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/649,048

(22) Filed: Aug. 26, 2003

(30) Foreign Application Priority Data
Apr. 16, 2003 (JP) 2003-110990

(51) Int. Cl. H04N 5/76; H04N 5/225; H04N 5/91

(52) U.S. Cl. 386/117; 348/207.99

(57) ABSTRACT

Image data is recorded both in a first recording format and in a second recording format having a lower coding rate than in the first recording format. Image data recorded in the first recording format is erased after transmitted to an external apparatus. Image data recorded in the second recording format is kept on an internal recording medium. Transmission to external increases the recording time available for image data. Even if the user requests to replay image data which has been erased after transmitted, it is possible to immediately replay the corresponding image data recorded in the second recording format without the necessity of reconnecting to the external apparatus and receiving the image data.

### FIELD OF THE INVENTION

The present invention relates to image data recording techniques and, in particular, to an image data recording technique which can compress image data simultaneously into a plurality of recording formats and, by transmitting image data to external, providing longer recording time.

### BACKGROUND OF THE INVENTION

Recently, camera-equipped compact apparatus capable of recording moving images are being developed one after another. Not limited to conventional moving image pickup cameras such as digital video cameras, the span of development is expanding to cover such tools as digital still cameras and camera-equipped mobile phones which are provided with a function of recording moving images.

Any of these image data recording apparatus has a recording medium and records image data in that recording medium. However, since the body of the apparatus must be miniaturized and the cost of the apparatus is under restriction as a product, the storage capacity of the recording medium is limited. Thus, it is not possible to provide sufficiently long recording time for the user in many cases.

With this background behind, there are methods employed generally to allow the user to record an image signal over a long period of time. One is to lower the coding rate of the image data while the other is to use a removable recording medium for exchange.

In addition, Japanese Patent Laid-Open No. 2002-101369 discloses a technique which can substantially makes the recording time longer limitlessly not depending on the storage device provided for the camera. In this method, generated image data is transmitted in real time to a remote server and, once transmitted to the server, image data is overwritten by new image data.

Disclosed in Japanese Patent Laid-Open No. 2002-209131 is an electronic camera which can not only transmit generated image data to an external image database for storage therein but also efficiently and exactly retrieve desired image data from an enormous amount of image data stored in the image database and quickly display the retrieved image data.

Another related technique is also disclosed in Japanese Patent Laid-Open No. 2003-116041. In this method, when no external apparatus such as a PC (Personal Computer) is connected, image data is stored in temporary recording means. Once an external apparatus is connected, the image data is compressed at different compression rates and one compressed image data is recorded on a recording medium while the other is transmitted to the external apparatus.

### SUMMARY OF THE INVENTION

Lowering the coding rate of image data for recording can increase the recording time but deteriorates the image quality.

Using a removable recording medium for recording image data also has a problem that images cannot be replayed when the recording medium is removed although the recording time can be increased.

According to the technique disclosed in Japanese Patent Laid-Open No. 2002-101369, image data in the camera unit can be erased to increase the recording time after generated image data is transmitted in real time to a remote server. However, if the user instructs the camera unit to replay image data, it is necessary to re-connect to the remote server and receive image data. Thus, images cannot quickly be replayed/displayed. Further, if the user moves to a place where communication is not possible with the server after the image data is transmitted and erased from the camera unit, past recorded images cannot be replayed at all. This is not desirable in view of usability.

According to the technique disclosed in Japanese Patent Laid-Open No. 2002-209131, when image data is transmitted, its thumbnail or size-reduced image is recorded in the electronic camera unit. At replay, image data reception is started after image data to be replayed is selected by the user. This method not only increases the recording time but also allows the user to easily check image data on the electronic camera unit. However, since each thumbnail is a size-reduced image and represents part of the corresponding images, it is not sufficient to rely only on such thumbnails when the user selects which image data to replay/display if moving images are to be replayed/displayed. Eventually, in order to determine which moving images to replay/display, reconnection with a remote server may become necessary to receive moving image data, making it impossible to quickly replay/display desired moving images. Further, if the user moves to a place where communication is not possible with the server, moving image data cannot be replayed.

In the case of the technique disclosed in Japanese Patent Laid-Open No. 2003-116041, since the storage capacity of the temporary recording means used to store image data before external equipment is connected is in the order of several MB at most, image data can not always be stored. This means that image data cannot always be compressed at different compression rates which are respectively for recording on a recording medium and transmission to external equipment.

It is an object of the present invention to provide an image data recording/reproducing technique which makes it possible to not only record more image data or increase the recording time for moving image data in particular but also quickly replay/display image data.

According to an aspect of the present invention to achieve the above-mentioned object, there is provided a method comprising the steps of: converting an image signal into a digital image signal; compressing the digital image signal into first image data according to a first recording format; compressing the digital image signal into second image data according to a second recording format which uses a lower coding rate than in the first recording format; recording the second image data in a recording medium; and transmitting the first image data to external equipment. Preferably, compressing the image signal into the first image data and transmitting the first image data to external equipment are done after connection is established with the external equipment.

According to another aspect of the present invention, there is provided a method comprising the steps of: converting an image signal into a digital image signal; compressing the digital image signal into first image data according to a first recording format; compressing the digital image signal into second image data according to a second recording format which uses a lower coding rate than in the first recording format; recording the first image data in a removable first recording medium; and recording the second image data in a built-in second recording medium. At replay, the second image data recorded in the second recording medium is elongated so that images based on the second image data are displayed on the display means.

### BRIEF DESCRIPTION OF THE DRAWINGS

FIG. 1 is a block diagram of a video camera to which an embodiment of the present invention is applied;

FIG. 2 shows an operational procedure of the video camera shown in FIG. 1;

FIG. 3 is a block diagram of a video camera to which another embodiment of the present invention is applied; and

FIG. 4 shows an operational procedure of the video camera shown in FIG. 3.

### DESCRIPTION OF THE PREFERRED EMBODIMENTS

Embodiments of the present invention will be described below with reference to the drawings.

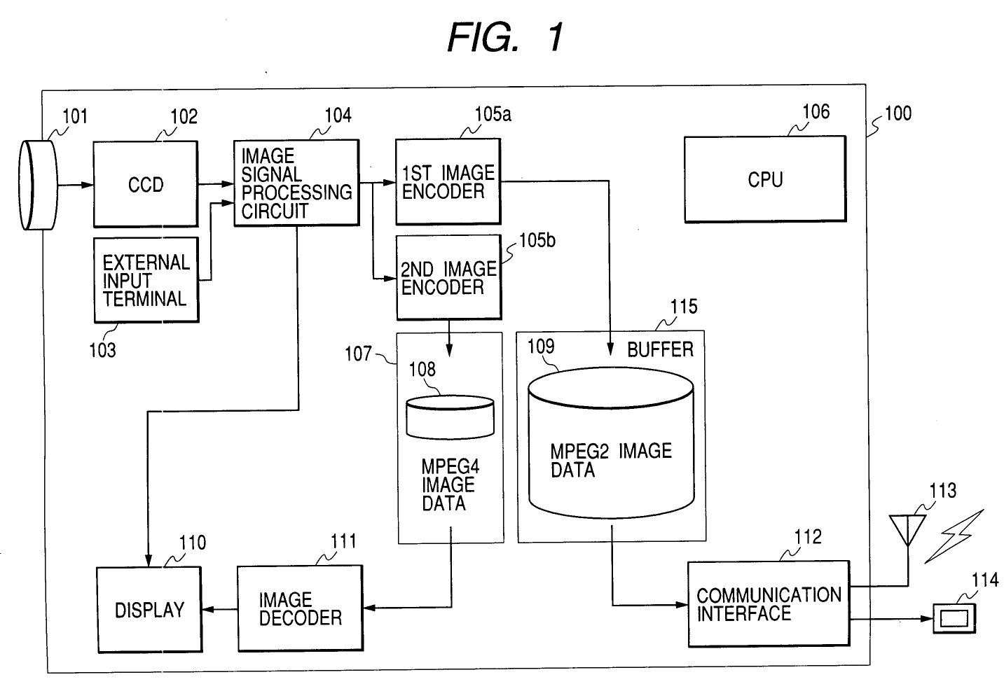

FIG. 1 is a block diagram of a video camera 100 which is implemented as an image data recording apparatus by applying the present invention. An image obtained through a lens 101 is converted to an image signal by a CCD (Charge Coupled Device) 102, image pickup means, and processed by an image signal processing circuit 104 containing a D/A converter and a digital signal processor to generate a digital image signal. Alternatively, a digital image signal may also be generated similarly by the image signal processing 104 from an image signal which is incoming via an external input terminal 103 from a video apparatus or the like.

The digital image signal is encoded to first recording format image data by a first image encoder 105a and also to second recording format image data by a second image encoder 105b. The coding rate in the second recording format is lower than that in the first recording format. Note that it is assumed in the following description that the MPEG2 (Moving Picture Experts Group 2) and MPEG4 formats are employed respectively as the first and second recording formats in the present embodiment.

If recording is started by the relevant operation, MPEG2 image data 109, encoded according to the first recording format, is temporally stored in a buffer 115 made of a semiconductor memory or the like while MPEG4 image data 108, compressed according to the second recording format, is recorded on a recording medium such as a hard disk by the drive 107. Note that a CPU (Central Processing Unit) is responsible for controlling each block of the video camera and managing image data management information such as recording time and vacant recording medium capacity.

The video camera 100 is provided with a communication interface 112 which allows connection with a network such as the Internet or an external apparatus such as a personal computer. If the video camera 100 can be connected to the network or external apparatus by using a radio antenna 113 or a USB (Universal Serial Bus) terminal 114 for wired communication, as shown in FIG. 1, the CPU 106 starts transmitting the MPEG2 image data 109 accumulated in the buffer 115 after completing connection means establishment, equipment authentication and the like.

If the video camera 100 is connected with a network such as the Internet or with an external apparatus such as a personal computer, the CPU 106 reads MPEG2 image data 109 from the buffer 115 and transmits the image data to external via the communication interface 112. After the MPEG2 image data 109 is transmitted to a network or external apparatus, the CPU 106 erases the MPEG2 image data 109 from the buffer 115 in order to secure a free space.

Since this configuration allows the video camera 100 to transmit image data stored temporally in the buffer 115 to a network or external apparatus while accumulating new image data in the buffer 115, it is possible to increase the recording time available for image data.

Although in this video camera 100, MPEG2 image data 109 is temporally stored in the buffer 115 before transmitted, the video camera 100 may also be configured in such a manner that a recording medium in the recording unit 107, instead of the buffer 115, is used for temporary storage. This configuration allows the user to continue image pickup even when the video camera 100 can not be connected to a network or external apparatus since the recording medium of the drive 107 has a larger capacity than the temporary storage means buffer 105. Later, the image data recorded in the drive 107 can be transmitted to a network or external apparatus. Needless to say, the video camera 100 can be configured that image data is recorded on the recording medium in the drive 107 instead of the buffer 105 even when connection is possible with a network or external apparatus.

Also note that a separate recording medium may be incorporated to buffer MPEG2 image data 109 besides the drive 107 and buffer 115.

The video camera 100 is provided with a display 110 to check the image pickup subject in terms of field angle, etc. While image data is recorded, images based on the image signal of the image signal processing circuit 104 appear on the display 110. If the user requests the video camera 100 to replay some recorded image data, the CPU 106 retrieves the corresponding MPEG4 image data 108 from a recording medium in the drive 107, decodes the retrieved image data to an image signal using an image decoder 111 and then makes the display 110 output images based on this image signal. The display 110 is a small device mounted on the image data recording apparatus. Practically, it is a display device using a liquid crystal panel, organic EL (Electro Luminescence) panel or the like.

Generally, since the size of the display 110 is limited to 3.5 inches at most due to the size of the video camera 100, the display area is small with low resolution. Thus, it is meaningless to replay such data-abundant image data as MEPG2 image data 109 on the image data recording apparatus 100. Image data recorded in a lower coding rate recording format may be sufficient to check the contents. Accordingly, MPEG4 image data 108 is used since its lower coding rate allows longer time image data to be recorded on the recording medium in the drive 107.

Note that the image signal processing circuit 104, first image encoder 105a, second image encoder 105b and image decoder 111 can be configured either as hardware circuits or as software programs in the CPU 106. That is, their practical configurations are not restricted as far as their aforementioned functions are implemented.

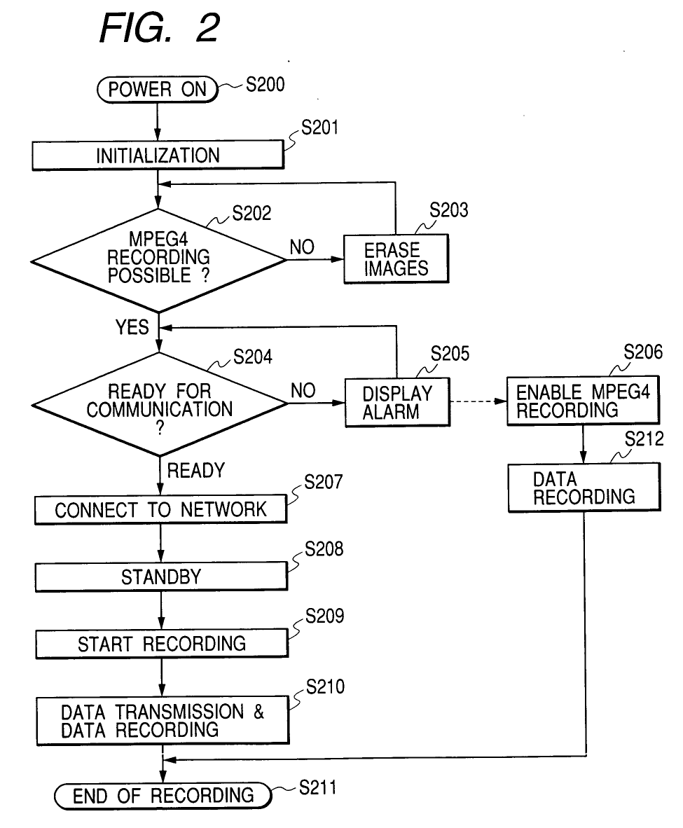

The following describes an operational procedure of the video camera 100, which concerns the present embodiment. FIG. 2 is a flowchart for explaining the operational procedure of the video camera 100. Each operational step described below is performed under the control of the CPU 106.

Firstly, if the power switch (not shown) of the video camera 100 is turned on (S200), the video camera 100 performs initialization (S201). During the initialization, it is checked whether the recording medium in the drive 107 has a vacant capacity enough large to record MPEG4 image data 108 (S202). If the vacant capacity is not enough large, the display 110 outputs a screen urging the user to erase MPEG4 image data which has been recorded (S203). Judgment on whether the vacant capacity is enough large or not may be done by comparing the vacant capacity with a certain value. This value is a time value in minutes such as one minute and five minutes or a data amount such as 1 MB and 5 MB and may be designed to be specifiable and changeable by the user. If MPEG4 image data 108 is erased by the user, a sufficient vacant capacity is secured on the recording medium in the drive 107 so as to allow progress to the subsequent steps.

Note that instead of step S203, this embodiment may also be designed in such a manner that the oldest MPEG4 image data 108 is overwritten by new MPEG4 image data 108 so as to automatically update the image data.

Then, it is checked whether the video camera 100 is ready for communication (S204). If the video camera 100 is ready for communication, the video camera 100 starts connecting to a network (S207) and establishes a link with a destination to which image data is to be transmitted by the video camera 100. If communication is not possible, the display 110 outputs an alarm screen indicating that the video camera 100 cannot be connected to the network (S205).

While this check is repeated until the video camera 100 becomes ready for communication, MPEG2 image data 109 is not recorded but recording of MPEG4 image data 108 is enabled (S206) to prevent such a situation where image recording cannot be done at all. Alternatively, this embodiment can be modified in such a manner that the display 100 outputs a screen urging the user to select one of the two. If the recording of only MPEG4 image data 108 is enabled, MPEG4 image data 108 is recorded on the recording medium in the drive 107 until the recording is terminated without generating/transmitting MPEG2 image data 109 (S212). How to transmit to the network is done as described earlier.

Meanwhile, if the video camera 100 has successfully connected to the network, it enters the standby state and remains ready for recording image data (S208). If image recording is started by the user (S209), the video camera 100 begins both transmitting MPEG2 image data 109 to the network and recording MPEG4 image data 108 on the recording medium in the drive 107 (S210). Transmission to the network and recording on the recording medium in the drive 107 are performed as described earlier. Finally, if the video camera 100 is operated by the user to stop the recording, the video camera 100 terminates the data transmission and data recording (S211).

As described so far, encoding picked up images into two different recording formats and recording them in the respective formats make it possible to replay images even after the image data is transmitted to external equipment from the video camera (image data recording apparatus). Further, since image data to be used for replay is encoded into the lower coding rate recording format, it is possible not only to provide increased recording time for image data but also to quickly replay/display image data. In particular, since the higher coding rate image data is encoded and transmitted after a link is established with external equipment, not only still images and but also moving image data can be treated.

Note that the recording medium used in the drive 107 is not limited to a specific type of medium and may be a hard disk, semiconductor memory, optical disk, optomagnetic disk or the like. In addition, the communication interface between the video camera 100 and external equipment is also not limited to a specific type and may be implemented by any of various ones including radio connection, wired connection and optical communication.

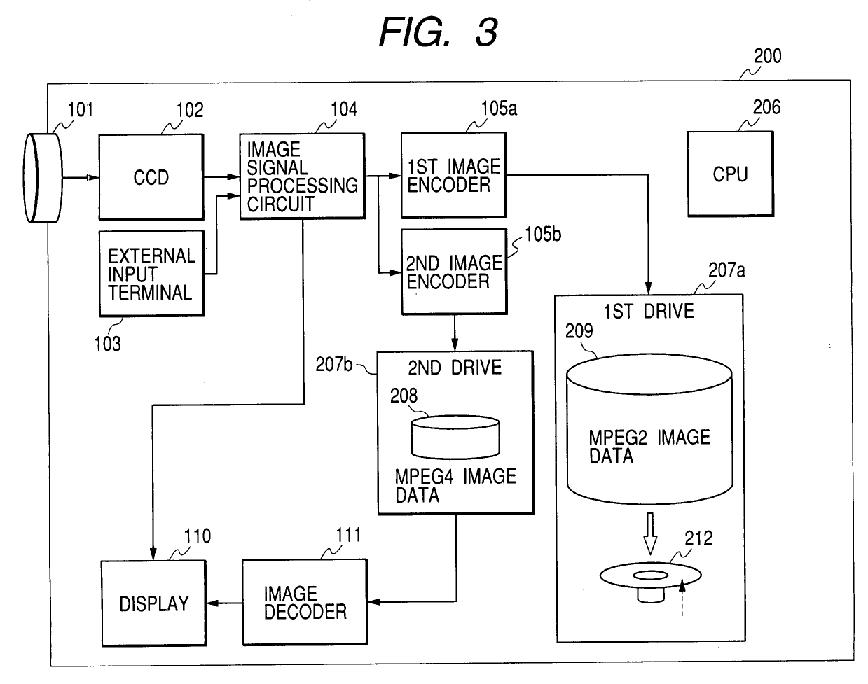

Then, another embodiment is described with reference to FIG. 3. FIG. 3 is a block diagram of this embodiment; a video camera 200 as an image data recording apparatus. Each section given the same number as in the aforementioned embodiment has the same function as the corresponding one and therefore is not described here. The following description is directed to what differs from the aforementioned embodiment.

If recording is started by the relevant operation, MPEG2 image data 209, encoded according to a first recording format, is recorded on an optical disk 212, an interchangeable recording medium in a first drive 207a while MPEG4 image data 208, encoded according to a second recording format, is recorded on a second recording medium, a fixed recording medium incorporated in a second drive 207b. Data management information, such as recording time and vacant recording medium capacity, is managed by a CPU 206.

If the user requests the video camera 200 to replay some recorded image data, the CPU 206 checks if the image data is recorded as MPEG2 image data 209 on the optical disk 212. If the image data is present on the optical disk 212, the CPU 206 controls the first drive 207a so as to replay the image data from the optical disk 212. Note that this scheme may be modified in such a manner that the corresponding MPEG4 image data is retrieved as described later regardless of whether the image data has been recorded on the optical disk 212 or not.

If there is no optical disk or the optical disk containing the corresponding first image data is replaced with another, no corresponding first image data is detected from the first drive 207a. In this case, under the control of the CPU 206, the corresponding MPEG4 image data 208 is retrieved from the recording medium in the drive 207b and decoded to an image signal by the image decoder 211 to be displayed on the display 210.

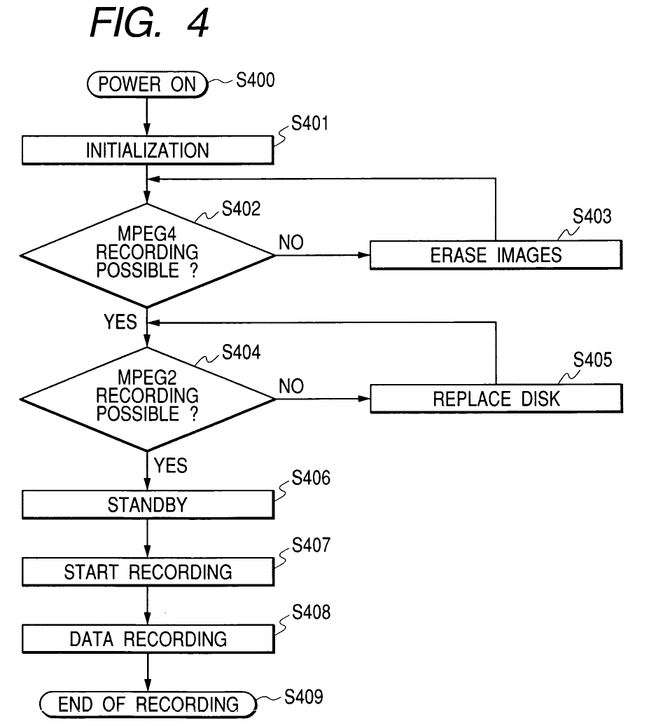

The following describes an operational procedure of the video camera 200, which concerns the present embodiment. FIG. 4 is a flowchart for explaining the operational procedure of the video camera 200. Each operational step described below is performed under the control of the CPU 206.

Steps S400, S401, S402 and S403 are same in operation as steps S200, S201, S202 and S203 shown in FIG. 3. Thus, their description is omitted here.

After the second drive 207b is verified as ready for recording MPEG4 image data (S402), it is checked whether the optical disk 212 has a vacant capacity enough large to record MPEG2 image data 209 (S404). If the vacant capacity is not so large, the display 110 outputs a screen urging the user to MPEG2 image data 209 or replace the recording medium 212, for example, an optical disk (S405). Judgment on whether the vacant capacity is enough large or not may be done by comparing the vacant capacity with a certain value. This value is a time value in minutes such as one minute and five minutes or a data amount such as 1 MB and 5 MB and may be designed to be specifiable and changeable by the user.

If the vacant capacity of the optical disk 212 is verified to be sufficient, the video camera 200 enters the standby state and remains ready for recording (S406). If image recording is started by the user (S407), the video camera 200 begins recording MPEG2 image data 209 on the optical disk 212 and MPEG4 image data 208 on a built-in recording medium, for example, a hard disk (S408). Finally, if the video camera 200 is operated by the user to stop the recording, the video camera 100 terminates the recording (S409). Note that recording on the recording media in the drives 107a and 107b is performed as described earlier.

If the optical disk 212 in the first drive 207a is used up during image pickup, the user may continues image pickup by replacing the optical disk 212. Even in this case, the present embodiment allows any recorded image data to be replayed immediately. This is because picked up images are compressed into two different recording formats for recording on not only the optical disk 212 but also on the non-interchangeable fixed recording medium in the second drive 207b. Thus, even after the optical disk 212 having some MPEG2 image data recorded thereon is replaced with another, it is possible to replay the corresponding image data from the second drive 207b without the necessity of mounting the replaced optical disk again. Further, since image data to be used for replay is encoded into the lower coding rate recording format, it is possible to provide increased recording time for image data.

This allows the user to replay long time image data without the necessity of searching image data stored in a plurality of recording media.

Note that although it is assumed above that the interchangeable recording medium is an optical disk and the non-interchangeable built-in recording medium is a hard disk, they are not limited to these media and may be any of various media including an optical disk, optomagnetic disk, tape, hard disk and semiconductor memory.

In addition, although the MPEG2 and MPEG4 recording formats are used in the embodiments described so far, it is a matter of course that non-MPEG recording formats can be used instead of the MPEG formats.

Further, although it is assumed that moving images are treated in the embodiments, not only still images but also non-image information data can also be treated. Due to the reason described below, however, these embodiments bring about more merit when moving images are recorded.

Finally, the following describes the advantages of the embodiments.

(1) Encoding (compressing) moving images requires more time than still images. In a conventional method, after an image is picked up, its thumbnail is created by the CPU. In the case of moving images, however, this method is not preferable in usability since it requires much time, forcing the user to wait without doing any other operation. If two kinds of image data are created during image pickup as in the embodiments, it is not necessary to spend excessive time after image pickup.

(2) In a conventional method, a thumbnail is selected and then the corresponding image data is received from a server. Replay of the image data is not possible until the reception is complete. Although still images can be received in a relatively short period of time, moving images require much time. In the case of moving images, the user must therefore wait for a long time until the moving images are replayed after they are selected, which lowers the usability. If reproducible moving images are recorded in the apparatus as in the embodiments, it is possible to quickly replay moving image data.

I claim:

1. An image data recording apparatus comprising:
image signal processing means for converting an image signal to a digital image signal;
first image compressing means for encoding said digital image signal to first image data according to first recording format;
second image compressing means for encoding said digital image signal to second image data according to second recording format whose coding rate is lower than the coding rate of the first recording format;
recording means for recording image data on a recording medium;
transmission means for transmitting image data to an external apparatus; and
control means for providing control so that said digital image signal is encoded to said second image and recorded on said recording medium, and after connection is established with the external apparatus, said digital image signal is encoded to said first image data and transmitted to the external apparatus via the transmission means.

2. An image data recording apparatus according to claim 1, wherein said control means provides further control so that if said recording medium has not a sufficient recording capacity, the recorded first image data is erased from said recording medium after said first image data is recorded on said recording medium and then transmitted via said transmission means to the external apparatus.

3. An image data recording apparatus according to claim 1 further comprising display means for displaying images, and image decoding means for decoding said second image data to an image signal which can be represented on said display means,
wherein said control means provides further control so that if an operation is made to instruct replay, said second image data recorded on said recording medium is decoded by said image decoding means and images are displayed on said display means based on the decoded second image data.

4. An image data recording and reproducing apparatus comprising:
image signal processing means for converting an image signal to a digital image signal;
first image encoding means for encoding said digital image signal to first image data according to first recording format;
second image encoding means for encoding said digital image signal to second image data according to second recording format whose coding rate is lower than the coding rate of the first recording format;
a first drive for recording and reproducing said first image data on and from an interchangeable first recording medium;
a second drive for recording and reproducing said second image data on and from a second recording medium therein;
a display means for displaying images;
image decoding means for decoding said second image data to an image signal which can be represented on said display means; and
control means for providing control so that said second image data recorded on said recording medium is decoded by said image decoding means and images are displayed on said display means based on the decoded second image data.

5. An image data recording and reproducing apparatus according to claim 4, wherein said control means provides further control so that if an operation is made to instruct replay image data but the requested image data cannot be replayed from said first drive, the corresponding second image data recorded on said second recording medium is decoded by said image decoded means and images are displayed on said display means based on the elongated second image data.

6. An image data recording and reproducing apparatus according to claim 4, wherein said control means provides further control so that if an operation is made to instruct replay image data and the requested image data can be replayed from said first drive, the corresponding first image data recorded on said first recording medium is decoded by said image decoding means and images are displayed on said display means based on the decoded first image data.

7. An image data recording method comprising the steps of:
establishing connection with an external apparatus;
converting an image signal to a digital image signal;
encoding said digital image signal to first image data according to first recording format;
encoding said digital image signal to second image data according to second recording format whose coding rate is lower than the coding rate of the first recording format;
recording said second image data on a recording medium; and
transmitting said first image data to said external apparatus.

8. An image data recording method according to claim 7, wherein said first image data is recorded on said recording medium and then transmitted to the external apparatus and the recorded first image data is erased from said recording medium after the transmission is complete.

9. An image data recording method according to claim 7 wherein if an operation is made to instruct replay, second image data recorded on said recording medium is decoded and images are displayed on display means based on the decoded second image data.

10. An image data recording and reproducing method comprising the steps of:
converting an image signal to a digital image signal;
encoding said digital image signal to first image data according to first recording format;
encoding said digital image signal to second image data according to second recording format whose coding rate is lower than the coding rate of the first recording format;
recording said first image data on an interchangeable first recording medium;
recording said second image data on second recording medium;
decoding second image data recorded on said second recording medium; and
displaying images on display means based on the decoded second image data.

11. An image data recording and reproducing method according to claim 10 wherein if it is requested to replay image data but the requested image data cannot be replayed based on the corresponding first image data, the corresponding second image data recorded on said second recording medium is decoded and images based on the elongated second image data are displayed.

12. An image data recording and reproducing method according to claim 10, wherein if it is requested to replay image data and the requested image data can be replayed based on the corresponding first image data, that first image data recorded on said first recording medium is decoded and images are displayed on said display means based on the decoded first image data.

13. An information recording method comprising the steps of:
establishing connection with an external apparatus;
converting an information signal to a digital information signal;
encoding said digital information signal to first information data according to first recording format;
encoding said digital information signal to second information data according to second recording format whose coding rate is lower than the coding rate of the first recording format;
recording said second information data on a recording medium; and
transmitting said first information data to said external apparatus.

14. An information recording and reproducing method comprising the steps of:
converting an information signal to a digital information signal;
encoding said digital information signal to first information data according to first recording format;
encoding said digital information signal to second information data according to second recording format whose coding rate is lower than the coding rate of the first recording format;
recording said first information data on an interchangeable first recording medium;
recording said second information data on second recording medium;
decoding second information data recorded on said second recording medium; and
displaying information on display means based on the decoded second information data.
